(19) United States
(12) Patent Application Publication
(10) Pub. No.: US 2015/0373615 A1
(43) Pub. Date: Dec. 24, 2015

(54) BASE STATION SHARING AIR INTERFACE RESOURCES BETWEEN ACCESS AND BACKHAUL

(71) Applicant: QUALCOMM Incorporated, San Diego, CA (US)

(72) Inventor: Karl Georg Hampel, New York, NY (US)

(21) Appl. No.: 14/692,620

(22) Filed: Apr. 21, 2015

Related U.S. Application Data
(60) Provisional application No. 62/013,958, filed on Jun. 18, 2014.

(51) Int. Cl. H04W 40/04; H04W 72/04; H04L 29/06

(52) U.S. Cl. CPC H04W 40/04; H04L 69/22; H04W 72/04

(57) ABSTRACT

Base stations with shared air interface between access and backhaul are provided. One method of base station communication includes allocating air interface resources of between mobile access links and backhaul links, receiving packets, routing, when the packets were received on a first backhaul link, the packets to a queue of a second backhaul link for transmission on select air interface resources, routing, when the packets were received on a third backhaul link, the packets using a routing layer function to a higher layer function, routing, when the packets were received from a first mobile access link, the packets to a queue of a fourth backhaul link for transmission on select air interface resources, and routing, when the packets were received from a fifth backhaul link, the packets to a queue of a second mobile link for transmission on select air interface resources.

### CROSS-REFERENCE TO RELATED APPLICATION(S)

This application claims priority to and the benefit of U.S. Provisional Application No. 62/013,958, Attorney Docket No. QCOM-2623P1 (144829P1), filed Jun. 18, 2014, the entire contents of which are incorporated herein by reference as if fully set forth below and for all applicable purposes.

### BACKGROUND

1. Field of the Disclosure

Aspects of the present disclosure relate generally to wireless communication systems, and more particularly, to a base station sharing air interface resources between access and backhaul functions.

2. Description of Related Art

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. One example of a telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

The increasing densification of wireless access systems elevates backhaul cost since every base station generally requires its own backhaul connection. The problem is especially pronounced for millimeter wave (mmWave) access technologies, which encounter elevated propagation loss and atmospheric absorption limiting the maximum possible cell size. Due to the small cell size, high cell densification appears to be the only option to achieve area coverage. This creates a problem for incremental deployment, which usually starts out with a few large cells to create area coverage and then gradually fills in cells when and where capacity is needed. Therefore, a solution is needed to mitigate the backhaul problem of highly densified access systems.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

One or more aspects of the present disclosure provide for a wireless access node, referred to as base station, which shares its air interface resources among links to mobile nodes and backhaul links to peer base stations. In such case, the base station can support two overlaid protocol layers on the same air interface, one defining a user-specific bearer plane and the other a backhaul routing plane. On the bearer plane, the base station can support user specific and service specific traffic management to enable policy support, charging support, and quality of service (QoS) support with per user per service granularity. On the routing plane, the base station can support an appropriate routing protocol among base stations and conventional routers to enable resilience to backhaul node failure. The base station can further support features for autonomous integration into the core network as a mobile access point as well as integration into the backhaul as a router.

In one aspect, the disclosure provides a method of wireless communication, including allocating air interface resources of a base station between mobile access links and backhaul links; receiving data packets at the base station; routing, when the data packets were received on a first backhaul link, the data packets to a queue of a second backhaul link for transmission on select air interface resources of the air interface resources allocated for the second backhaul link; routing, when the data packets were received on a third backhaul link, the data packets using a routing layer function to a higher layer function for local processing; routing, when the data packets were received from a first mobile access link, the data packets to a queue of a fourth backhaul link for transmission on select air interface resources of the air interface resources allocated for the fourth backhaul link; and routing, when the data packets were received from a fifth backhaul link, the data packets to a queue of a second mobile link for transmission on select air interface resources of the air interface resources allocated for the second mobile link.

Another aspect of the disclosure provides an apparatus for wireless communication, including a memory device and a processing circuit coupled to the memory device. The processing circuit is configured to allocate air interface resources of a base station between mobile access links and backhaul links; receive data packets at the base station; route, when the data packets were received on a first backhaul link, the data packets to a queue of a second backhaul link for transmission on select air interface resources of the air interface resources allocated for the second backhaul link; route, when the data packets were received on a third backhaul link, the data packets using a routing layer function to a higher layer function for local processing; route, when the data packets were received from a first mobile access link, the data packets to a queue of a fourth backhaul link for transmission on select air interface resources of the air interface resources allocated for the fourth backhaul link; and route, when the data packets were received from a fifth backhaul link, the data packets to a queue of a second mobile link for transmission on select air interface resources of the air interface resources allocated for the second mobile link.

Another aspect of the disclosure provides an apparatus for wireless communication. The apparatus includes means for allocating air interface resources of a base station between mobile access links and backhaul links; means for receiving data packets at the base station; means for routing, when the data packets were received on a first backhaul link, the data packets to a queue of a second backhaul link for transmission on select air interface resources of the air interface resources allocated for the second backhaul link; means for routing, when the data packets were received on a third backhaul link, the data packets using a routing layer function to a higher layer function for local processing; means for routing, when the data packets were received from a first mobile access link, the data packets to a queue of a fourth backhaul link for transmission on select air interface resources of the air interface resources allocated for the fourth backhaul link; and means for routing, when the data packets were received from a fifth backhaul link, the data packets to a queue of a second mobile link for transmission on select air interface resources of the air interface resources allocated for the second mobile link.

Another aspect of the disclosure provides a non-transitory computer-readable medium storing computer-executable code, including code to allocate air interface resources of a base station between mobile access links and backhaul links; receive data packets at the base station; route, when the data packets were received on a first backhaul link, the data packets to a queue of a second backhaul link for transmission on select air interface resources of the air interface resources allocated for the second backhaul link; route, when the data packets were received on a third backhaul link, the data packets using a routing layer function to a higher layer function for local processing; route, when the data packets were received from a first mobile access link, the data packets to a queue of a fourth backhaul link for transmission on select air interface resources of the air interface resources allocated for the fourth backhaul link; and route, when the data packets were received from a fifth backhaul link, the data packets to a queue of a second mobile link for transmission on select air interface resources of the air interface resources allocated for the second mobile link.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

FIG. 1 is a schematic diagram illustrating an example of a small cell network where one base station has a managed backhaul link and the other base stations have formed a self-backhaul network in accordance with some aspects of the disclosure.

FIG. 2 is a diagram illustrating an example of a network architecture in which aspects of the disclosure may be implemented.

FIG. 3 is a functional block diagram illustrating an example of a base station with a wireless access function for sharing air interface resources between mobile access and backhaul in accordance with some aspects of the disclosure.

FIG. 4 is a schematic diagram of an exemplary user plane protocol stack for a routing plane and a bearer plane in accordance with some aspects of the disclosure.

FIG. 5 is a functional block diagram illustrating the example base station of FIG. 3 with a line indicative of a first user plane data flow superimposed on the block diagram in accordance with some aspects of the disclosure.

FIG. 6 is a functional block diagram illustrating the example base station of FIG. 3 with a line indicative of a second user plane data flow superimposed on the block diagram in accordance with some aspects of the disclosure.

FIG. 7 is a functional block diagram illustrating the example base station of FIG. 3 with a line indicative of a third user plane data flow superimposed on the block diagram in accordance with some aspects of the disclosure.

FIG. 8 is a functional block diagram illustrating the example base station of FIG. 3 with a line indicative of a fourth user plane data flow superimposed on the block diagram in accordance with some aspects of the disclosure.

FIG. 9 is a functional block diagram illustrating the example base station of FIG. 3 with a line indicative of a fifth user plane data flow superimposed on the block diagram in accordance with some aspects of the disclosure.

FIG. 10 is a functional block diagram illustrating the example base station of FIG. 3 with a line indicative of a sixth user plane data flow superimposed on the block diagram in accordance with some aspects of the disclosure.

FIG. 11 is a flow chart illustrating an exemplary process for operating a wireless access function for sharing air interface resources between mobile access and backhaul in accordance with some aspects of the disclosure.

FIG. 12 illustrates a block diagram of an exemplary hardware implementation for an apparatus that supports communication in accordance with some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In one aspect the present disclosure provides for a wireless access node, referred to as base station, which shares its air interface resources among links to mobile nodes and backhaul links to peer base stations using a method. The method can include allocating air interface resources of the base station between mobile access links and backhaul links, receiving data packets at the base station, routing, when the data packets were received on a first backhaul link, the data packets to a queue of a second backhaul link for transmission on select air interface resources of the air interface resources allocated for the second backhaul link, routing, when the data packets were received on a third backhaul link, the data packets using a routing layer function to a higher layer function for local processing, routing, when the data packets were received from a first mobile access link, the data packets to a queue of a fourth backhaul link for transmission on select air interface resources of the air interface resources allocated for the fourth backhaul link, and routing, when the data packets were received from a fifth backhaul link, the data packets to a queue of a second mobile link for transmission on select air interface resources of the air interface resources allocated for the second mobile link.

In this way, the base station can effectively support two overlaid protocol layers on the same air interface, one defining a user-specific bearer plane and the other a backhaul routing plane. On the bearer plane, the base station can support user specific and service specific traffic management to enable policy support, charging support, and quality of service (QoS) support with per user per service granularity. On the routing plane, the base station can support an appropriate routing protocol among base stations and conventional routers to enable resilience to backhaul node failure. The base station can further support features for autonomous integration into the core network as a mobile access point as well as integration into the backhaul as a router.

As to more on the need for the approaches presented in this disclosure, present cellular data networks using multi-access wireless technologies such as W-CDMA or LTE can be deployed in an incremental manner. Deployments generally start with a sparse network of macro-cells providing area coverage while traffic load is still small. As traffic grows, cell split or local deployment of Pico cells permits gradual adaptation to the increasing capacity demand. Such an incremental deployment strategy has made the rollout of new access technologies economically viable.

The development of new cellular access technologies at higher frequency bands such as millimeter waves (mmWaves) or using unlicensed bands demands a new deployment paradigm. While these access technologies promise very high data rates due to their large bandwidth, they suffer from an inherently smaller cell size which is due to enhanced propagation loss and atmospheric absorption at higher carrier frequencies or unmanaged interference encountered in an unlicensed spectrum. Consequently, the advantages of these technologies can remain confined to a small cell footprint unless a high density of cells is deployed.

High densification of cells usually requires many managed backhaul links, which interconnect the small cell base stations to the core network. Managed backhaul links are expensive due to the associated infrastructure costs, operation costs, and leasing costs. Therefore, this procedure prohibits incremental rollout of extended area coverage in a cost effective manner.

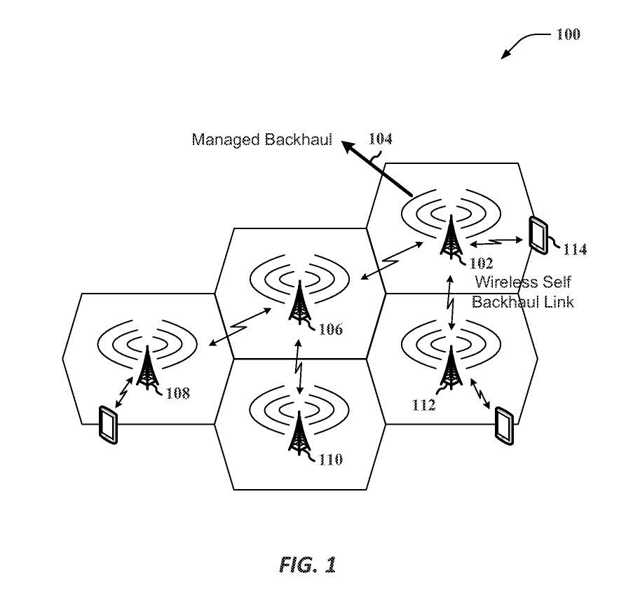

This disclosure proposes to pursue another strategy for incremental deployment of small cell access technologies. Since these technologies have high air-interface capacity they can share this capacity between access and backhaul. In this manner, the base stations can self-backhaul traffic by extending the backhaul routing plane across a wireless mesh while providing access to mobile nodes at the same time. This reduces the number of managed backhaul points (e.g., fiber access points) needed for a highly densified access network and the associated backhaul cost (see FIG. 1).

FIG. 1 is a schematic diagram illustrating an example of a small cell network 100 where one base station 102 has a managed backhaul link 104 and the other base stations (106, 108, 110, 112) have formed a self-backhaul network in accordance with some aspects of the disclosure. In conventional systems, every base station in such a cell network might have its own managed backhaul link.

In the small cell network of FIG. 1, as long as mobile traffic is low, air interface resource sharing between access and backhaul provides high throughput at the access links over an extended coverage area. When traffic load increases, managed backhaul links can be gradually filled in.

For some access technologies, such as mmWaves, it is even possible to efficiently share resources between mobile access and backhaul via means of spatial multiplexing using beam forming. This efficiency gain reduces the need for additional managed backhaul points even at high capacity demand, making network operation more cost effective.

The air interface sharing mobile access/backhaul network is realized via wireless access nodes, referred to as base stations (BSs, see for example BS 102), which support wireless access links to mobile nodes (e.g., mobile node 114) as well as to neighbor base station nodes using a wireless access function that will be described in more detail below.

In an aspect, the network 100 includes a base station (BS) 102 and user equipment (UE) 114. The base station may also be referred to by those skilled in the art as a base transceiver station (BTS), a radio base station, a radio transceiver, a transceiver function, a basic service set (BSS), an extended service set (ESS), an access point (AP), a Node B, an eNode B (eNB), mesh node, relay, or some other suitable terminology. A base station may provide wireless access points to a core network for any number of user equipment (UE). Examples of a UE include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, entertainment device, wearable communication device, automobile, mesh network node, M2M component, a game console, or any other similar functioning device. The UE may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology.

The modulation and multiple access scheme employed by the wireless network 100 may vary depending on the particular telecommunications standard being deployed. In LTE applications, orthogonal frequency division multiplexing (OFDM) is used on the downlink (DL) and single carrier frequency divisional multiple access (SC-FDMA) is used on the uplink (UL) to support both frequency division duplexing (FDD) and time division duplexing (TDD). As those skilled in the art will readily appreciate from the detailed description to follow, the various concepts presented herein are well suited for LTE and 5G applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization.

The actual wireless communication standard and the multiple access technology employed will depend on the specific application and the overall design constraints imposed on the system. The base station (BS) 102 may have multiple antennas supporting multiple-input multiple-output (MIMO) technology. The use of MIMO technology enables the BS 102 to exploit the spatial domain to support spatial multiplexing, beamforming, and transmit diversity.

Spatial multiplexing may be used to transmit different streams of data simultaneously on the same frequency. The data steams may be transmitted to a single UE 114 to increase the data rate or to multiple UEs to increase the overall system capacity. This is achieved by spatially precoding each data stream (i.e., applying a scaling of an amplitude and a phase) and then transmitting each spatially precoded stream through multiple transmit antennas on the downlink. The spatially precoded data streams arrive at the UE(s) with different spatial signatures, which enables each of the UE(s) to recover the one or more data streams destined for that UE 114. On the uplink, each UE transmits a spatially precoded data stream, which enables the BS 102 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

The various concepts presented throughout this disclosure may be implemented across a broad variety of telecommunication systems, network architectures, and communication standards. Existing wireless communication networks, such as those defined according to 3GPP standards for the evolved packet system (EPS), frequently referred to as long-term evolution (LTE) networks, may be suitable. Evolved versions of this network, such as a fifth-generation (5G) network, may provide for many different types of services or applications, including but not limited to web browsing, video streaming, VoIP, mission critical applications, multi-hop networks, remote operations with real-time feedback (e.g., tele-surgery), etc.

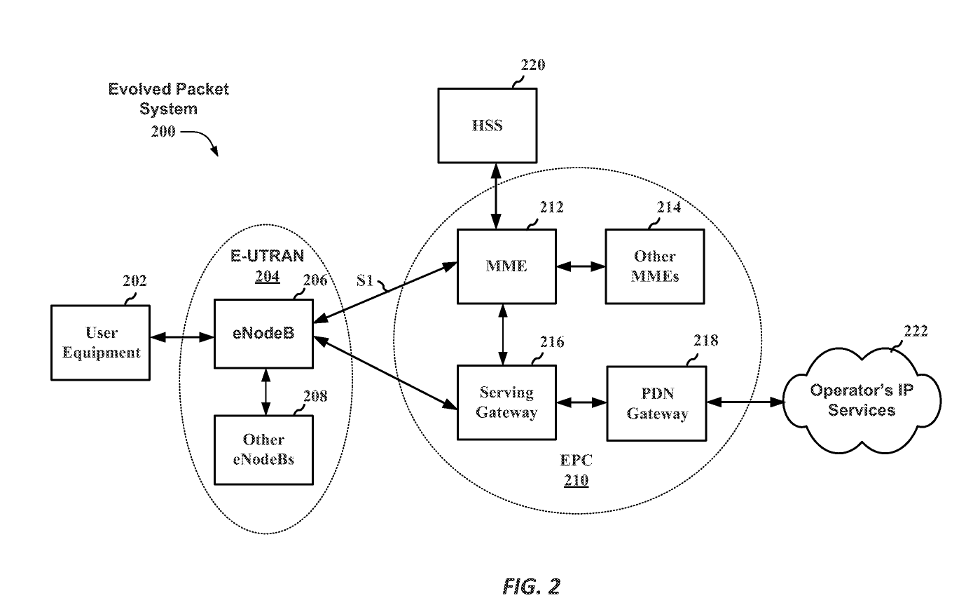

Aspects of the present disclosure are not limited to a particular generation of wireless networks but are generally directed to wireless communication and specifically to LTE and 5G networks. However, to facilitate an understanding of such aspects with a known communication platform, examples of such involving LTE are presented in FIG. 2.

FIG. 2 is a diagram illustrating an LTE network architecture 200 employing various apparatuses in which aspects of the disclosure may be implemented. The LTE network architecture 200 may be referred to as an Evolved Packet System (EPS) 200. The EPS 200 may include one or more user equipment (UE) 202, an Evolved UMTS Terrestrial Radio Access Network (E-UTRAN) 204, an Evolved Packet Core (EPC) 210, a Home Subscriber Server (HSS) 220, and an Operator's IP Services 222. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 206 and other eNBs 208. The eNB 206 provides user and control plane protocol terminations toward the UE 202. The eNB 206 may be connected to the other eNBs 208 via an X2 interface (i.e., backhaul). The eNB 206 may also be referred to by those skilled in the art as a base station (e.g., see 102 in FIG. 1), a base transceiver station, a radio base station, a radio transceiver, a transceiver function, a basic service set (BSS), an extended service set (ESS), or some other suitable terminology. The eNB 206 provides an access point to the EPC 210 for a UE 202. Examples of UEs 202 are described above. The UE 202 may also be referred to by those skilled in the art using other terms such as is described above.

The eNB 206 is connected by an S1 interface to the EPC 210. The EPC 210 includes a Mobility Management Entity (MME) 212, other MMEs 214, a Serving Gateway 216, and a Packet Data Network (PDN) Gateway 218. The MME 212 is the control node that processes the signaling between the UE 202 and the EPC 210. Generally, the MME 212 provides bearer and connection management. All user IP packets are transferred through the Serving Gateway 216, which itself is connected to the PDN Gateway 218. The PDN Gateway 218 provides UE IP address allocation as well as other functions. The PDN Gateway 218 is connected to the Operator's IP Services 222. The Operator's IP Services 222 include the Internet, the Intranet, an IP Multimedia Subsystem (IMS), and a PS Streaming Service (PSS).

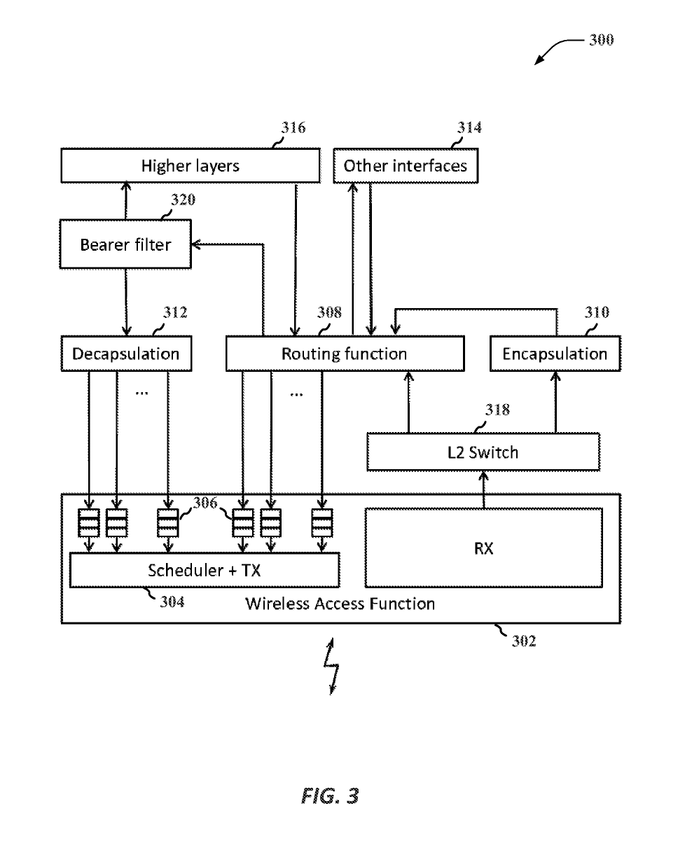

FIG. 3 is a functional block diagram illustrating an example of a base station 300 (e.g., see eNB 206 in FIG. 2) with a wireless access function 302 for sharing air interface resources between mobile access and backhaul in accordance with some aspects of the disclosure. The wireless access function 302 uses a scheduler 304 to share air interface resources for transmission among mobile access and backhaul links. It may also use the scheduler 304 to allocate resources for mobile nodes and peers for their respective transmissions. Resource sharing may occur in the space domain, time domain, frequency domain, code domain, or a combination of these domains.

The wireless access function 302 also supports signaling with mobiles and peer base stations to establish and tear down air interface links, and to coordinate traffic exchange on established links. For data transmission, the wireless access function 302 supports multiple queues 306, where at least one queue is dedicated for each mobile access link and at least one for each backhaul link. The base station 300 may support additional interfaces using other access technologies, such as wireline or wireless technologies for example.

The base station 300 further includes a routing function 308, an encapsulation function 310, and a decapsulation function 312. The base station routing function 308 relays traffic on the routing layer between backhaul links of the wireless access function 302, encapsulation function 310, decapsulation function 312, other interfaces 314 and higher layers 316 on the base station of the backhaul plane. The encapsulation and decapsulation functions (310, 312) enable traffic relaying between mobiles and the core network on a bearer layer, which resides on top of the routing layer. The operations of this base station 300 will be described in greater detail below.

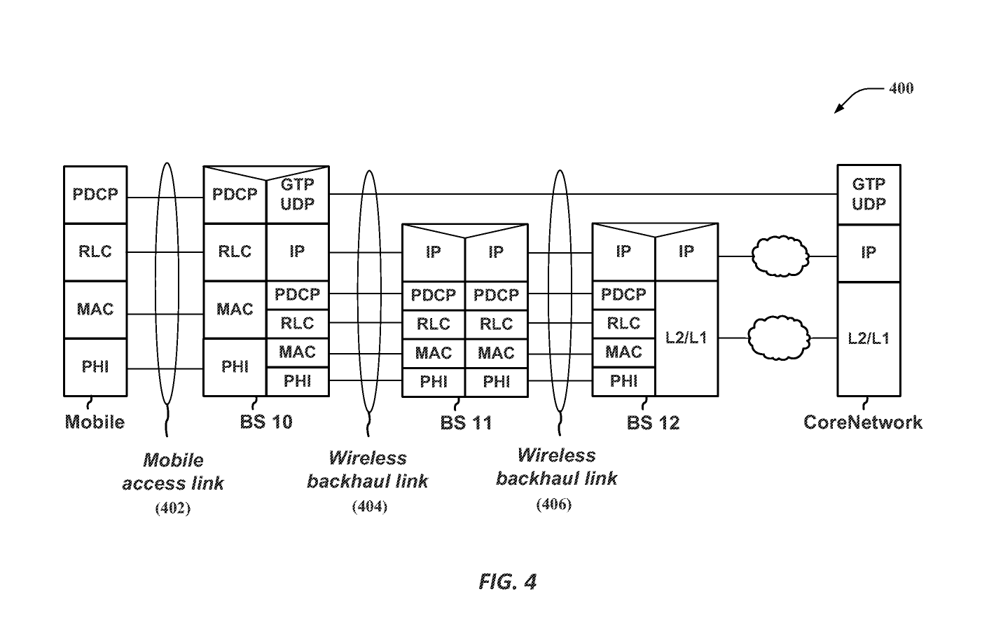

FIG. 4 is a schematic diagram of an exemplary user plane protocol stack 400 for a routing plane and a bearer plane. In this example, the routing plane uses internet protocol (IP) and the bearer plane uses general packet radio service tunneling protocol (GTP)/user datagram protocol (UDP) encapsulation on top of the routing plane. The routing function 308 supports a routing protocol with peer base stations (see BS 11 in communication with BS 10 and BS 12 in FIG. 4) or other routers. The routing function 308 may be implemented, for example, in BS 10 which has a mobile access link 402, a wireless backhaul link 404, and a wireless link 406 to the core network (see also base station 300 in FIG. 3 and base station 102 in FIG. 1). For the routing function 308, each air interface link backhaul is regarded as a separate port. Further, the encapsulation and decapsulation functions (310, 312) are each regarded as a virtual port. The routing function 308 may have additional physical ports in case it supports additional wireline or wireless access technologies. The routing function 308 may also exchange data with higher layers 316 on the base station 300.

In one aspect, all traffic relayed from a mobile link to the core network passes through the encapsulation and decapsulation functions (310, 312), which encapsulates the mobile packet with an appropriate routing header and forwards it to the routing function 308. In such case, all traffic, that arrives at the routing function 308 from the core network and is destined for a mobile, is forwarded by the routing function 308 to the encapsulation function 310, which strips the routing header before passing it on to the air interface layer. The base station 300 further supports signaling protocols to create, manage, and tear down bearers with the core network.

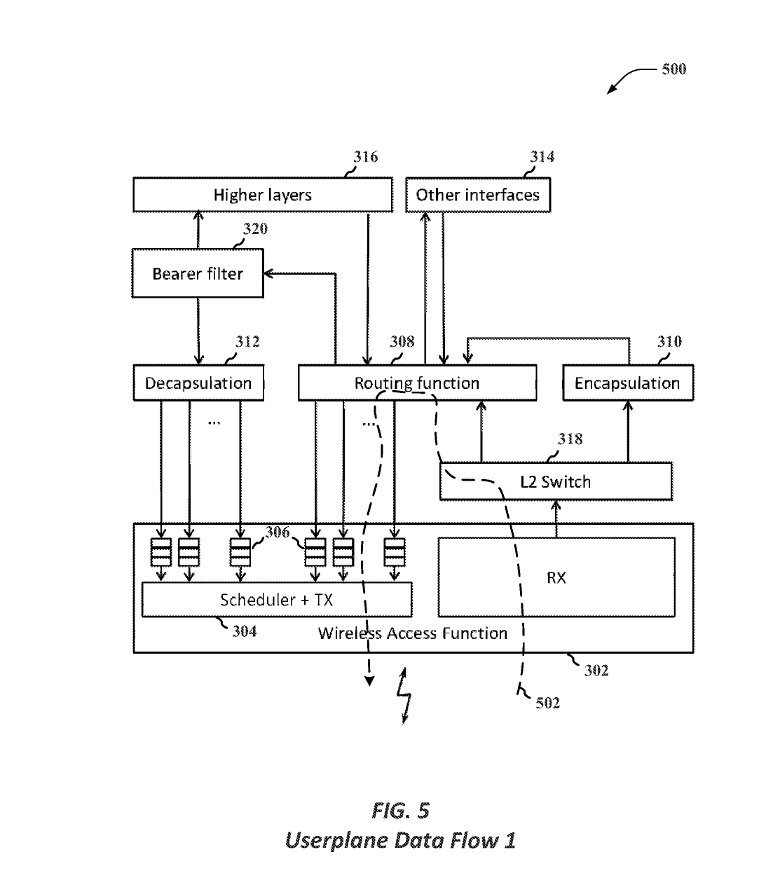

Aspects of the disclosure thus involve certain modes of user plane data flow, which are described in detail below in reference to FIGS. 5-10.

FIG. 5 is a functional block diagram 500 illustrating the example base station of FIG. 3 with a line indicative of a first user plane data flow 502 superimposed on the block diagram in accordance with some aspects of the disclosure. As to the first user plane data flow 502 (e.g., first mode of user plane data flow), first consider data flow from one wireless backhaul to another wireless backhaul. Data packets arriving from a peer base station on a backhaul link of the wireless access function are passed from receive circuitry (RX), via a L2 switch 318, to the routing function 308. Based on the routing header entries, the routing function 308 forwards the packets to a port, which represents another backhaul link of the wireless access function 302, and where they are added to the backhaul link's queue 306 for air interface scheduling (see also BS 11 in FIG. 4). In one embodiment, the L2 switch 318 identifies these packets by their specific media access control (MAC) address which refers to the link end point the base station has with a peer base station. Further, the routing function 308 performs port selection by matching the packet header's destination IP address to next hop entries on a routing table, where the routing table has been generated by a routing protocol.

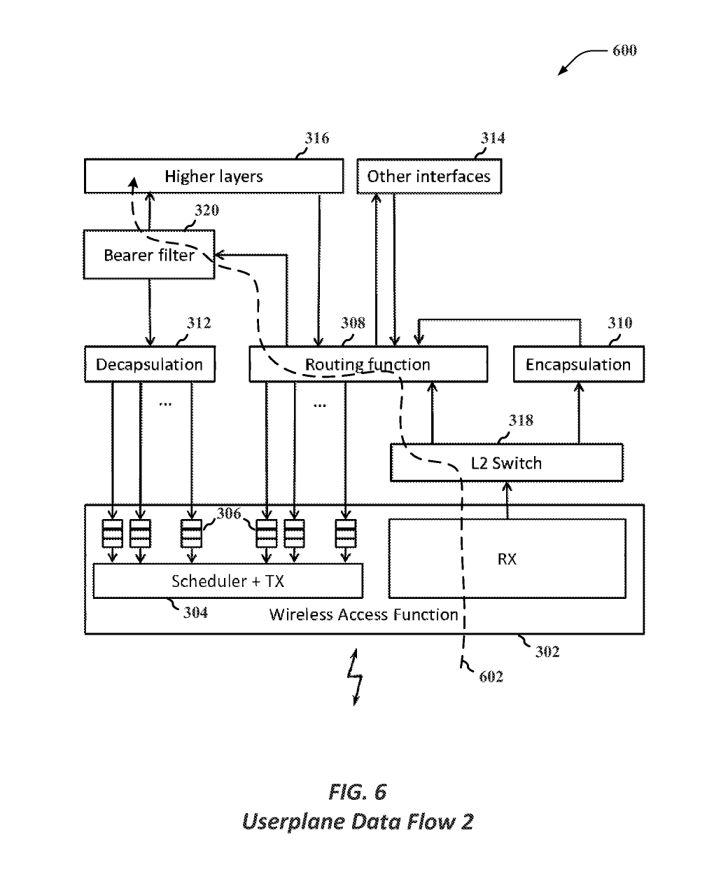

FIG. 6 is a functional block diagram 600 illustrating the example base station of FIG. 3 with a line indicative of a second user plane data flow 602 superimposed on the block diagram in accordance with some aspects of the disclosure. As to the second user plane data flow 602 (e.g., second mode of user plane data flow), consider data flow from a wireless backhaul to a higher layer 316. Data packets arriving from a peer base station on a backhaul link of the wireless access function 302 are passed on to the routing function 308. Based on the routing header entries, the routing function 308 forwards the packets to a bearer filter function 320, which then forwards them to a higher layer function 316 residing on the base station 300. In one embodiment, this forwarding can apply to all those packets whose destination IP address matches a local IP address of the base station 300. Further, the bearer filter function decision may be based on the absence of a GTP user data tunneling (GTP-U) header, which can be identified by the UDP port number. It may also be based on the presence of a set of transport connection identifiers consisting of IP addresses, transport layer protocol type and port numbers, which may refer to transport layer processes presently running on the base station.

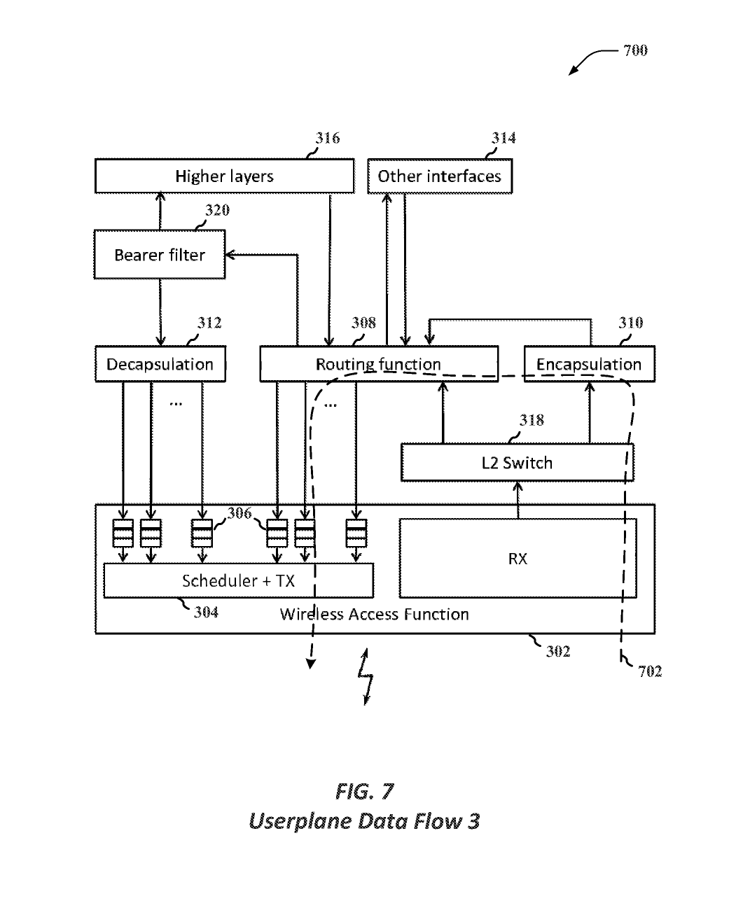

FIG. 7 is a functional block diagram 700 illustrating the example base station of FIG. 3 with a line indicative of a third user plane data flow 702 superimposed on the block diagram in accordance with some aspects of the disclosure. As to the third user plane data flow 702 (e.g., third mode of user plane data flow), consider data flow from a mobile device (e.g., mobile access) to a wireless backhaul. Data packets arriving on a mobile access link of the wireless access function 302 are passed on via the L2 switch 318 to the encapsulation function 310, which adds a routing header and forwards them to the routing function 308.

Based on the routing header entries, the routing function 308 forwards the packets to a port, which represents a backhaul link of the wireless access function (see e.g., BS 10 in FIG. 4), and where they are added to the backhaul link's queue 306 for air interface scheduling. In one embodiment, the L2 switch 318 identifies these packets by their specific MAC address which refers to an access link end point the base station has with a mobile device. The encapsulation function 310 can further add an IP-UDP-GTP header stack onto the packet where it derives the GTP and IP header field values from a lookup table, which holds the mapping of these values for the associated wireless access MAC address. This mapping may be established via signaling between the base station and the core network during bearer establishment such as discussed in the 3GPP TS 36.300 and 3GPP TS 23.401 specifications, which are hereby incorporated by reference in their entirety. The routing decision can be based on the same criteria as in the first mode of user plane data flow described above.

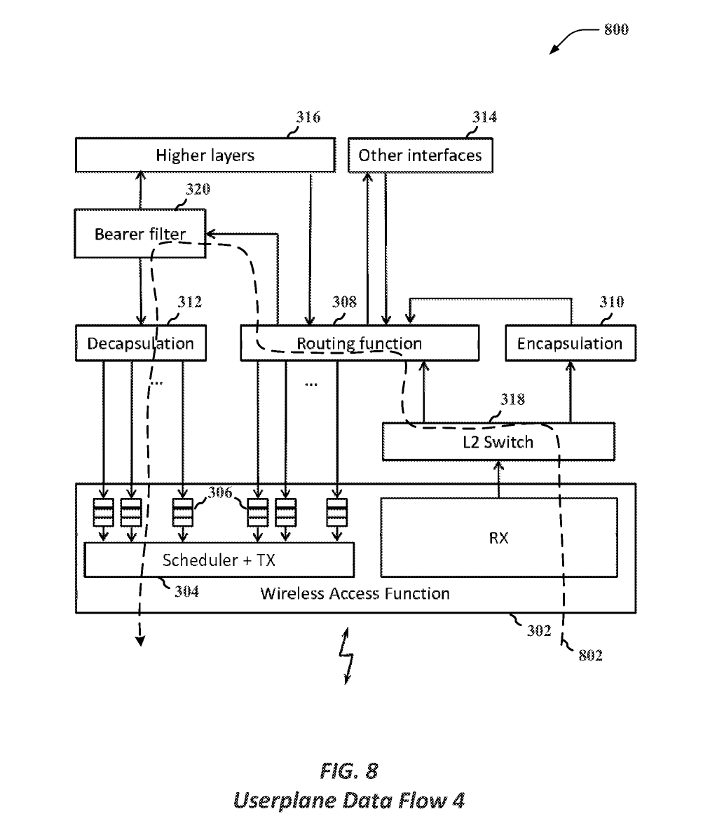

FIG. 8 is a functional block diagram 800 illustrating the example base station of FIG. 3 with a line indicative of a fourth user plane data flow 802 superimposed on the block diagram in accordance with some aspects of the disclosure. As to the fourth user plane data flow 802 (e.g., fourth mode of user plane data flow), consider data flow from a wireless backhaul to a mobile device (e.g., mobile access). Data packets arriving on a backhaul link of the wireless access function 302 are passed on via the L2 switch 318 to the routing function 308. Based on the routing header entries, the routing function 308 passes the packets to the bearer filter 320, which forwards them to the decapsulation function 312.

The decapsulation function 312 strips the routing header and forwards them to the wireless access function 302, where they are added to a mobile link's queue 306 for air interface scheduling. In one embodiment, the L2 switch 318 identifies these packets by their specific MAC address, which refers to the link end point the base station has with a peer base station. The routing function 308 can further apply this decision to all of those packets whose destination IP address matches a local IP address of the base station. The bearer filter function 320 decision may be based on the presence of a GTP-U header, which can be identified by the UDP port number. The decapsulation function 312 identifies the mobile link's queue 306 based on a lookup table holding the mapping between the MAC address of the mobile access link and the fields on the GTP or IP header stripped from the packets, such as the Tunnel-End-Point-Id or destination IP address for example. This mapping may be established via signaling between the base station and the core network during bearer establishment such as discussed in the 3GPP TS 36.300 and 3GPP TS 23.401 specifications. The decapsulation function 312 can be executed by BS 10 in FIG. 4.

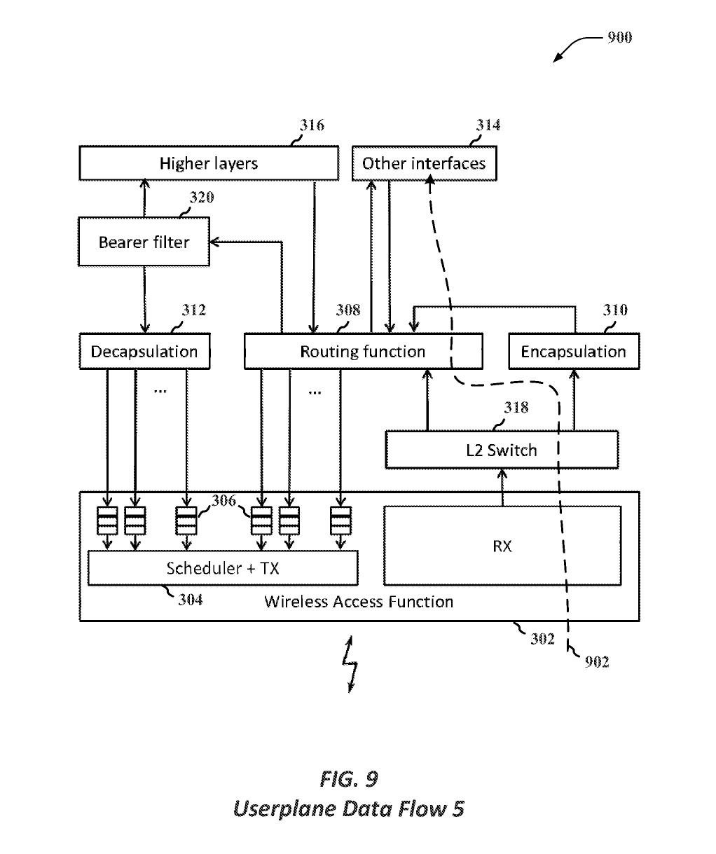

FIG. 9 is a functional block diagram 900 illustrating the example base station of FIG. 3 with a line indicative of a fifth user plane data flow 902 superimposed on the block diagram in accordance with some aspects of the disclosure. As to the fifth user plane data flow 902 (e.g., fifth mode of user plane data flow), consider data flow from a wireless backhaul to a managed backhaul. Data packets arriving on a backhaul link of the wireless access function 302 are passed on via the L2 switch 318 to the routing function 308. Based on the routing header entries, the routing function 308 forwards the packets to a port, which represents another physical interface (see e.g., BS 12 in FIG. 4). In one embodiment, the steps affecting L2 switch 318 and routing function 308 are executed as discussed above for the first mode of user plane data flow.

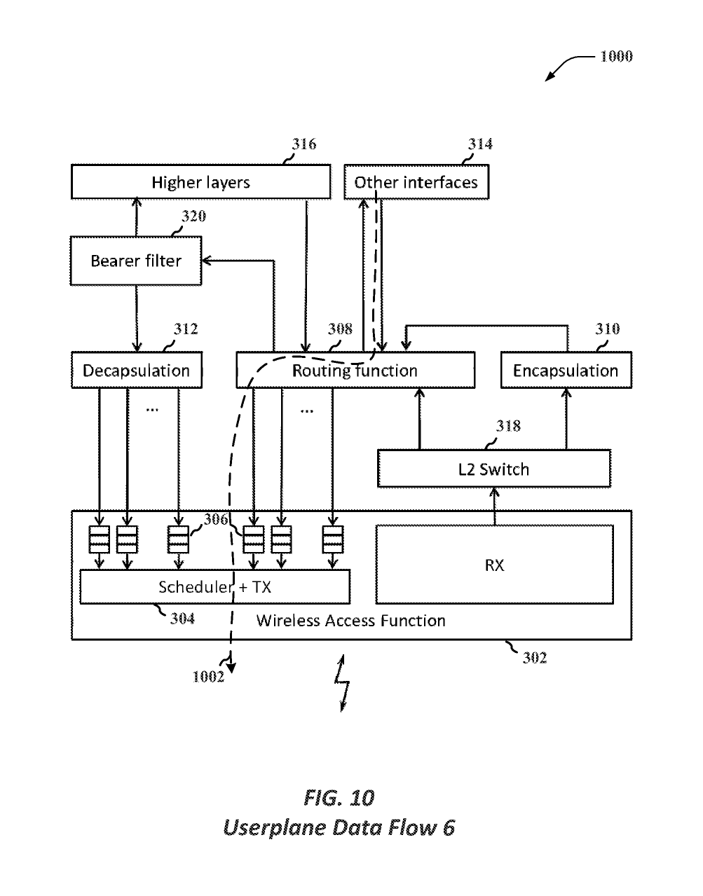

FIG. 10 is a functional block diagram 1000 illustrating the example base station of FIG. 3 with a line indicative of a sixth user plane data flow 1002 superimposed on the block diagram in accordance with some aspects of the disclosure. As to the sixth user plane data flow 1002 (e.g., sixth mode of user plane data flow), consider data flow from a managed backhaul to a wireless backhaul. Data packets arriving on a port of another physical interface 314 are passed on to the routing function 308. Based on the routing header entries, the routing function 308 forwards the packets to a port, which represents another backhaul link of the wireless access function 302, and where they are added to the backhaul link's queue 306 for air interface scheduling (see e.g., BS 12 in FIG. 4). In one embodiment, the steps affecting routing function 308 and wireless access function 302 are executed as discussed above for the third mode of user plane data flow.

There are other user plane data flows such as from managed backhaul (other interfaces) to mobile access and vice versa, which are supported by conventional base stations, and can be supported by base station 300.

The routing can be based on IP. In such case, the routing decisions are based on IP addresses as conducted by typical routers. Any IP routing protocol can be used on the routing plane among the base stations, including protocols such as open shortest path first (OSPF), border gateway patrol (BGP), optical label switched path (OLSP), or ad hoc on demand vector routing (AODV). Alternatively, software defined networking (SDN) based protocols such as OpenFlow can be used instead of a routing protocol. The routing protocol can be extended beyond the wireless access interface to other physical interfaces supported on some (or all) base stations.

The encapsulation and decapsulation operations (conducted by the encapsulation and decapsulation functions) can add/remove an IP header to/from the packet, respectively. They may add and remove additional headers. The bearer may be realized via encapsulations such as GTPU-UDP-IP, IP-GRE-IP, IP-in-IP or others, where GRE is generic routing encapsulation. For GTP-UDP-IP, the encapsulation and decapsulation operations can add/remove the entire GTP-UDP-IP header stack. Bearer management can be performed via the protocols supported by 3GPP System Architecture Evolution such as S1-AP or X2-AP (applies to GTP-U/UDP/IP encapsulations).

The routing layer can also be realized as an L2 forwarding plane such as those supported by IEEE 802.1 protocols. In this case, the routing function can represent an L2 switch or bridge. In a similar manner, a forwarding protocol such as rapid spanning tree protocol (RSTP) or shortest path bridging (SPB) can be used. Also, SDN based protocols such as OpenFlow can be used as a bridging protocol.

When Ethernet is chosen for such a forwarding plane, the bearer layer may be realized via 802.1ah (e.g., Q-in-Q encapsulation), 802.1aq (e.g., MAC-in-MAC encapsulation, provider backhaul bridge) or Ethernet II (IP-in-Ethernet). In this latter case, bearers may be identified by end point IP addresses and eventually also transport layer port numbers. Bearer management can be realized via Dynamic Host Configuration Protocol (DHCP), Address Resolution Protocol (ARP) and Neighbor Discovery Protocol (NDP) in case IP-in-Ethernet encapsulation is used for the bearer plane.

Aspects of the disclosure apply to any type of air interface such as LTE and Wi-Fi. Aspects of the disclosure may be especially applicable to air interfaces operating in unlicensed spectrum and/or mmWave frequency bands. Aspects of the disclosure may be especially suitable for air interfaces which support beam steering and other smart antenna technologies such as MIMO. These technologies permit spatial separation among backhaul and access links.

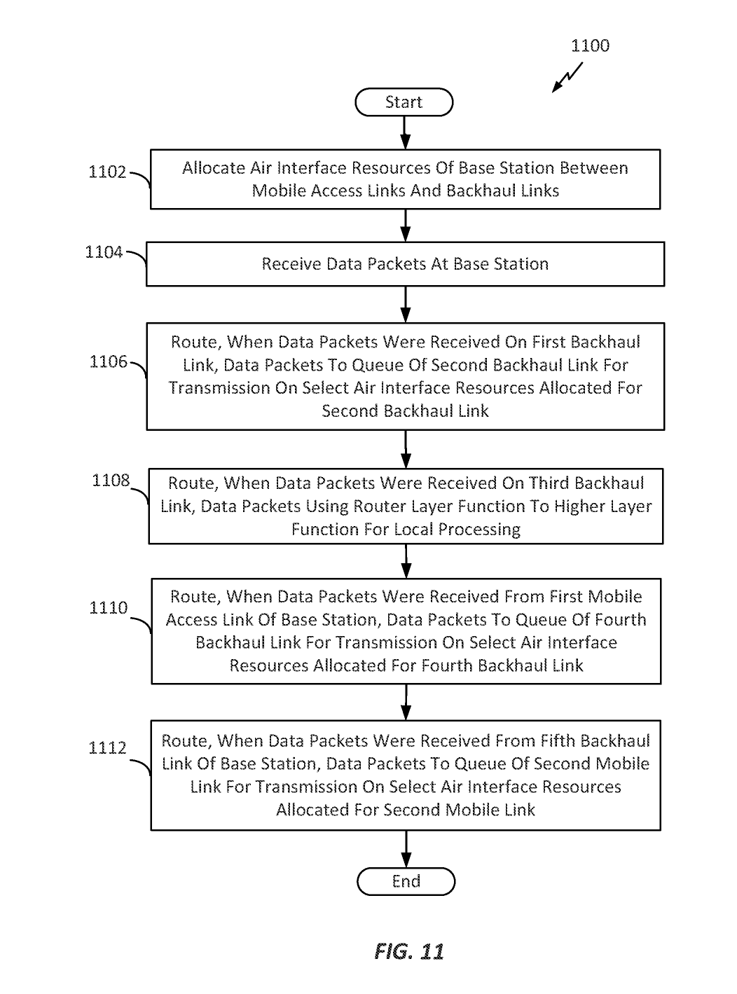

FIG. 11 is a flow chart illustrating an exemplary process 1100 for operating a wireless access function for sharing air interface resources between mobile access and backhaul. In one aspect, the process 1100 can be executed by the wireless access function in any of the base stations of FIGS. 3, 5-10. In block 1102, the process allocates air interface resources of a base station between mobile access links and backhaul links. In block 1104, the process receives data packets at a base station.

In block 1106, the process routes, when the data packets were received on a first backhaul link, the data packets to a queue of a second backhaul link for transmission on select air interface resources of the air interface resources allocated for the second backhaul link. In one aspect for block 1106, the process routes, when the data packets were received from a peer base station of the base station on a first backhaul link and based on routing header entries of the data packets, the data packets to a port for a second backhaul link and adds the data packets to a queue for transmission on the air interface via the second backhaul link. In an aspect for block 1106, the process can follow the actions described above for the first mode of user plane flow 502 in FIG. 5 (e.g., in a backhaul link to backhaul link flow).

In block 1108, the process routes, when the data packets were received on a third backhaul link, the data packets using a routing layer function to a higher layer function (e.g., another layer function) for local processing. In one aspect for block 1108, the process routes, when the data packets were received from a peer base station of the base station on the third backhaul link and based on routing header entries of the data packets, the data packets using a routing layer function to a higher layer function for local processing. In one aspect, the higher layer function is higher than the routing layer function in the network model of FIG. 3 (e.g., like the hierarchy of layers in the open systems interconnect (OSI) network model). In an aspect for block 1108, the process can follow the actions described above for the second mode of user plane flow 602 in FIG. 6 (e.g., in a backhaul link to local processing flow).

In block 1110, the process routes, when the data packets were received from a first mobile access link of the base station, the data packets to a queue of a fourth backhaul link for transmission on select air interface resources of the air interface resources allocated for the fourth backhaul link. In one aspect for block 1110, the process encapsulates and routes the data packets, when the data packets were received from the first mobile access link of the base station, to a port for the fourth backhaul link and adds the data packets to the queue for transmission on the air interface via the fourth backhaul link. In an aspect for block 1110, the process can follow the actions described above for the third mode of user plane flow 702 in FIG. 7 (e.g., in a mobile link to backhaul link flow). In some aspects for block 1110, the process involves encapsulating and routing the data packets to the queue of the fourth backhaul link for transmission on select air interface resources of the air interface resources allocated for the fourth backhaul link. In one such aspect, the encapsulating can involve adding an IP header to each of the data packets.

In block 1112, the process routes, when the data packets were received from a fifth backhaul link of the base station, the data packets to a queue of a second mobile link for transmission on select air interface resources of the air interface resources allocated for the second mobile link. In one aspect for block 1112, the process routes, decapsulates, and forwards the data packets, when the data packets were received from the fifth backhaul link of the base station and based on routing header entries of the data packets, to a port for a second mobile link and adds the data packets to a queue for transmission on the air interface via the second mobile link. In an aspect for block 1112, the process can follow the actions described above for the fourth mode of user plane flow 802 in FIG. 8 (e.g., in a backhaul link to mobile link flow). In some aspects for block 1112, the process involves routing, decapsulating, and forwarding the data packets to the queue of the second mobile link for transmission on select air interface resources of the air interface resources allocated for the second mobile link. In one such aspect, the routing is performed using Internet Protocol (IP), and the decapsulating involves removing an IP header from each of the data packets.

In an aspect, the process can further include routing, when the data packets were received from a sixth backhaul link, the data packets to a physical interface of a managed backhaul link. In an aspect, the process can further include routing, when the data packets were received from a port of a physical interface of a managed backhaul link, the data packets to a queue of a seventh backhaul link for transmission on select air interface resources of the air interface resources allocated for the seventh backhaul link.

In an aspect, the process can further involve transmitting, when the data packets were received on the first backhaul link, second data packets derived from the data packets of the queue of the second backhaul link on the select air interface resources of the air interface resources allocated for the second backhaul link, transmitting, when the data packets were received from the first mobile access link, third data packets derived from the data packets of the queue of the fourth backhaul link on select air interface resources of the air interface resources allocated for the fourth backhaul link, and transmitting, when the data packets were received from the fifth backhaul link, fourth data packets derived from the data packets of the queue of the second mobile link on select air interface resources of the air interface resources allocated for the second mobile link. In such case, the second data packets, third data packets and fourth data packets can be derived from the originally queued packets and appropriate changes in routing information to realize the wireless access function (e.g., routing packets to/from backhaul links, mobile access links, local functions, and all possible combinations thereof).

In another aspect, the process may be performed as follows. First, the process can send a first signaling packet via a wireless air interface containing a local return address (this can be the base station's backhaul address). The packet can refer to any request (e.g., a DNS request). Second, the process can receive a second signaling packet via the wireless air interface containing the local return address as destination and information on a core-network address (this may be the response to the first packet, e.g. a DNS response). Third, the process can receive a third signaling packet via the wireless air interface from a mobile device containing a first information related to the mobile device (e.g., this can be a NAS service request). Fourth, the process can send a fourth signaling packet via the wireless air interface to the core network address containing second information derived in part from the first information (e.g., forward the NAS service request to the core network). Fifth, the process can receive from the core network address a signaling packet via the wireless air interface with a third information (e.g., response from the core network for the mobile device). Sixth, the process can establish a state for the mobile device from the second and third information including a local and a remote bearer address (e.g., tunnel establishment for mobile-device). Seventh, the process can identify data packets arriving on the wireless air interface based on the local bearer address and forwarding the packets on the wireless interface to the mobile device (e.g., tunnel decapsulation). Eight, the process can identify data packets arriving on the wireless air interface from the mobile and forwarding the packets to the remote bearer address (e.g., tunnel encapsulation). In other embodiments, other suitable actions can be performed. The process actions described in this paragraph can be used in conjunction with the above described process actions to establish one or more of the routing connections.

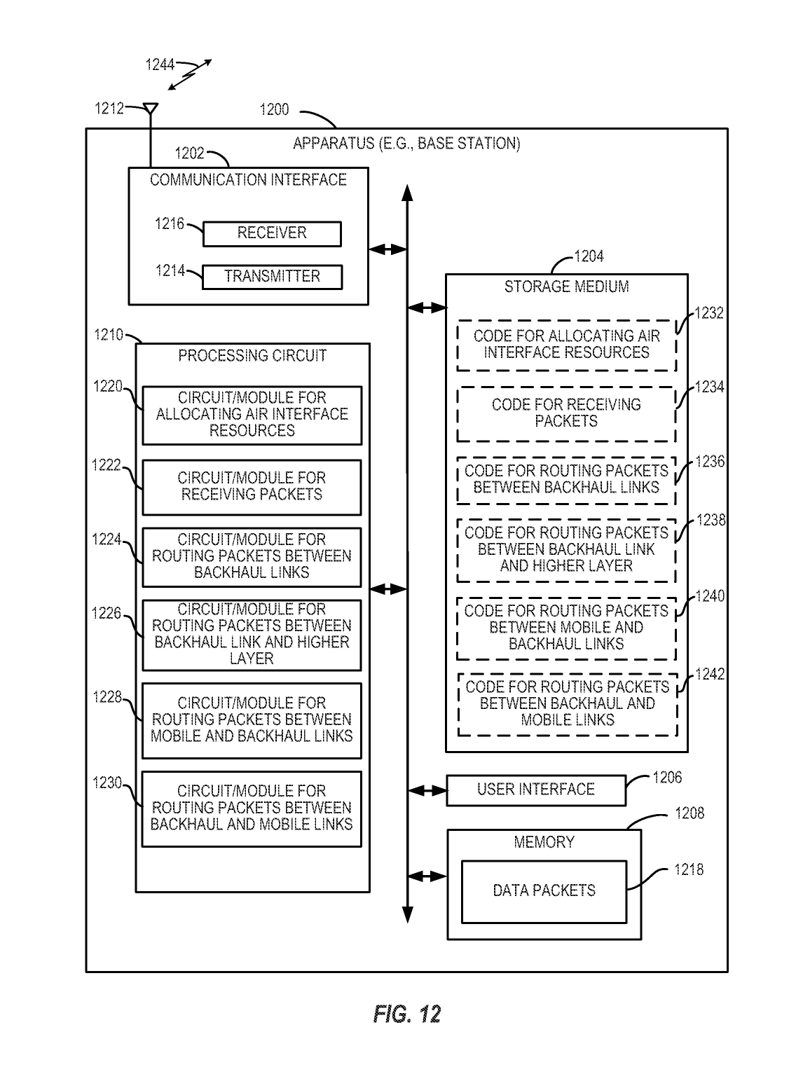

FIG. 12 illustrates a block diagram of an exemplary hardware implementation for an apparatus 1200 that supports communication in accordance with some aspects of the disclosure. For example, the apparatus 1200 could embody or be implemented within a network device (e.g., a base station, an eNB, a core network entity, etc.), or some other type of device that supports wireless communication. In various implementations, the apparatus 1200 could embody or be implemented within an access point, or some other type of device. In various implementations, the apparatus 1200 could embody or be implemented within a server, a personal computer, and or any other electronic device having circuitry. Apparatus 1200 could embody or be implemented within any of the base stations of FIGS. 3, 5-10.

The apparatus 1200 includes a communication interface (e.g., at least one transceiver) 1202, a storage medium 1204, a user interface 1206, a memory device 1208 (e.g., storing data packets 1218), and a processing circuit (e.g., at least one processor) 1210. In various implementations, the user interface 1206 may include one or more of: a keypad, a display, a speaker, a microphone, a touchscreen display, of some other circuitry for receiving an input from or sending an output to a user. The communication interface 1202 may be coupled to one or more antennas 1212, and may include a transmitter 1214 and a receiver 1216.

These components can be coupled to and/or placed in electrical communication with one another via a signaling bus or other suitable component, represented generally by the connection lines in FIG. 12. The signaling bus may include any number of interconnecting buses and bridges depending on the specific application of the processing circuit 1210 and the overall design constraints. The signaling bus links together various circuits such that each of the communication interface 1202, the storage medium 1204, the user interface 1206, and the memory device 1208 are coupled to and/or in electrical communication with the processing circuit 1210. The signaling bus may also link various other circuits (not shown) such as timing sources, peripherals, voltage regulators, and power management circuits, which are well known in the art, and therefore, will not be described any further.

The communication interface 1202 provides a means for communicating with other apparatuses over a transmission medium. In some implementations, the communication interface 1202 includes circuitry and/or programming adapted to facilitate the communication of information bi-directionally with respect to one or more communication devices in a network. In some implementations, the communication interface 1202 is adapted to facilitate wireless communication of the apparatus 1200. In these implementations, the communication interface 1202 may be coupled to one or more antennas 1212 as shown in FIG. 12 for wireless communication within a wireless communication system. The communication interface 1202 can be configured with one or more standalone receivers and/or transmitters, as well as one or more transceivers. In the illustrated example, the communication interface 1202 includes a transmitter 1214 and a receiver 1216. The communication interface 1202 serves as one example of a means for receiving and/or means transmitting.

The memory device 1208 may represent one or more memory devices. As indicated, the memory device 1208 may maintain data packet information 1218 along with other information used by the apparatus 1200. In some implementations, the memory device 1208 and the storage medium 1204 are implemented as a common memory component. The memory device 1208 may also be used for storing data that is manipulated by the processing circuit 1210 or some other component of the apparatus 1200.

The storage medium 1204 may represent one or more computer-readable, machine-readable, and/or processor-readable devices for storing programming, such as processor executable code or instructions (e.g., software, firmware), electronic data, databases, or other digital information. The storage medium 1204 may also be used for storing data that is manipulated by the processing circuit 1210 when executing programming. The storage medium 1204 may be any available media that can be accessed by a general purpose or special purpose processor, including portable or fixed storage devices, optical storage devices, and various other mediums capable of storing, containing or carrying programming.

By way of example and not limitation, the storage medium 1204 may include a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The storage medium 1204 may be embodied in an article of manufacture (e.g., a computer program product). By way of example, a computer program product may include a computer-readable medium in packaging materials. In view of the above, in some implementations, the storage medium 1204 may be a non-transitory (e.g., tangible) storage medium.

The storage medium 1204 may be coupled to the processing circuit 1210 such that the processing circuit 1210 can read information from, and write information to, the storage medium 1204. That is, the storage medium 1204 can be coupled to the processing circuit 1210 so that the storage medium 1204 is at least accessible by the processing circuit 1210, including examples where at least one storage medium is integral to the processing circuit 1210 and/or examples where at least one storage medium is separate from the processing circuit 1210 (e.g., resident in the apparatus 1200, external to the apparatus 1200, distributed across multiple entities, etc.).

Programming stored by the storage medium 1204, when executed by the processing circuit 1210, causes the processing circuit 1210 to perform one or more of the various functions and/or process operations described herein. For example, the storage medium 1204 may include operations configured for regulating operations at one or more hardware blocks of the processing circuit 1210, as well as to utilize the communication interface 1202 for wireless communication utilizing their respective communication protocols.

The processing circuit 1210 is generally adapted for processing, including the execution of such programming stored on the storage medium 1204. As used herein, the terms “code” or “programming” shall be construed broadly to include without limitation instructions, instruction sets, data, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

The processing circuit 1210 is arranged to obtain, process and/or send data, control data access and storage, issue commands, and control other desired operations. The processing circuit 1210 may include circuitry configured to implement desired programming provided by appropriate media in at least one example. For example, the processing circuit 1210 may be implemented as one or more processors, one or more controllers, and/or other structure configured to execute executable programming. Examples of the processing circuit 1210 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 1210 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 1210 are for illustration and other suitable configurations within the scope of the disclosure are also contemplated.

According to one or more aspects of the disclosure, the processing circuit 1210 may be adapted to perform any or all of the features, processes, functions, operations and/or routines for any or all of the apparatuses described herein. For example, the processing circuit 1210 may be configured to perform any of the steps, functions, and/or processes described with respect to FIGS. 1-11. As used herein, the term “adapted” in relation to the processing circuit 1210 may refer to the processing circuit 1210 being one or more of configured, employed, implemented, and/or programmed to perform a particular process, function, operation and/or routine according to various features described herein.

The processing circuit 1210 may be a specialized processor, such as an application specific integrated circuit (ASIC) that serves as a means for (e.g., structure for) carrying out any one of the operations described in conjunction with FIGS. 1-11. The processing circuit 1210 serves as one example of a means for transmitting and/or a means for receiving. The processing circuit 1210 serves as one example of a means for routing, a means for encapsulating, a means for decapsulating, and a means for allocating.

According to at least one example of the apparatus 1200, the processing circuit 1210 may include one or more of a circuit/module for allocating air interface resources 1220, a circuit/module for receiving packets 1222, a circuit/module for routing data packets between backhaul links (e.g., from a first backhaul to a second backhaul) 1224, a circuit/module for routing data packets between a backhaul link and a higher layer function 1226, a circuit/module for routing data packets between mobile and backhaul links (e.g., from a mobile link to a backhaul link) 1228, or a circuit/module for routing data packets between backhaul and mobile links (e.g., from a backhaul link to a mobile link) 1230. In one aspect, the processing circuit 1210 may also include other circuits/modules implementing any of the functions described above in reference to FIGS. 1-11, and particularly the functions described above in reference to FIGS. 9-10. In one aspect, for example, the processing circuit 1210 may also include other circuits/modules for transmitting data packets.

As mentioned above, programming stored by the storage medium 1204, when executed by the processing circuit 1210, causes the processing circuit 1210 to perform one or more of the various functions and/or process operations described herein. For example, the programming, when executed by the processing circuit 1210, may cause the processing circuit 1210 to perform the various functions, steps, and/or processes described herein with respect to FIGS. 1-11 in various implementations. As shown in FIG. 12, the storage medium 1204 may include one or more of the code for allocating air interface resources 1232, the code for receiving data packets 1234, the code for routing data packets between backhaul links (e.g., from a first backhaul to a second backhaul) 1236, the code for routing data packets between a backhaul link and a higher layer function 1238, the code for routing data packets between a mobile link and a backhaul link (e.g., from a mobile link to a backhaul link) 1240, or the code for routing data packets between a backhaul link and a mobile link (e.g., from a backhaul link to a mobile link) 1242. In one aspect, the storage medium 1204 may also include one or more of the code for performing any of the functions described above in reference to FIGS. 1-11, and particularly the functions described above in reference to FIGS. 9-10. In one aspect, for example, the storage medium 1204 may also include one or more of the code for transmitting data packets.

The base station 1200 may include various air interface resources 1244, including for example mobile access links and backhaul links. The links may be established and torn down in accordance with the functions and methods described above.

The base station can further support mechanisms to autonomously integrate itself into the routing plane and into the core network. For an Evolved Packet Core (EPC) and an LTE air interface, such a mechanism may involve one or more of the following actions:

(1) Upon booting, the base station (BS1) may attach to an operating base station (BS2) like a mobile device. In this manner, BS1 can connect to the core network and retrieve operator specific configuration information from operations and maintenance (OAM). This action follows in a manner analogous to the Phase-1 bootstrapping procedure for 3GPP Relay Nodes (e.g., in accordance with the 3GPP TS 36.300 specification). After this, BS1 may detach from BS2.

(2) BS1 may attach as a peer base station to BS2. In such case, it may use the same radio resource control (RRC) procedure as a mobile to base station attachment but BS1 flags that it is a base station rather than a mobile device. The security association between BS1 and BS2 is established analogue to the Phase-2 bootstrapping procedure for 3GPP Relay Nodes (e.g., in accordance with the 3GPP TS 36.300 specification).

(3) For an IPv6 routing plane, BS1 may initially appear as a host to BS2. In such case, BS2 therefore advertises a prefix for the air interface link with BS1 via the Router-Advertising-Message of the Neighbor Discovery Protocol (NDL, IETF RFC 4861). Based on this prefix, BS1 may select an IPv6 address using State-Less Address Auto-Configuration (e.g., in accordance with the IETF RFC 2460 specification). This can allow BS1 to access the backhaul network like a conventional base station.

(4) BS1 may integrate into the core network like an eNB integrates into EPC (e.g., in accordance with the 3GPP TS 32.501 specification). At this point, BS1 can operate as an autonomous BS for mobile nodes.

(5) BS1 may initiate the routing protocol provided by OAM as described in action (1) above. In the case of optimized link state routing (OLSR), for instance, it may exchange “Hello” messages with BS2.

(6) Upon attachment of another base station (BS3), BS1 may furnish the link to this base station with a unique prefix and advertise this prefix toward BS1. In one aspect, this prefix should not collide with existing prefixes in the subnet. For this purpose, BS1 may contact the OAM function on the core network, which creates a new collision-free prefix for this subnet.

As those skilled in the art will readily appreciate, various aspects described throughout this disclosure may be extended to any suitable telecommunication systems, network architectures and communication standards. By way of example, various aspects may be applied to UMTS systems such as W-CDMA, TD-SCDMA, and TD-CDMA. Various aspects may also be applied to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems, including those described by yet-to-be defined wide area network standards. The actual telecommunication standard, network architecture, and/or communication standard employed will depend on the specific application and the overall design constraints imposed on the system. One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein. Additional elements, components, steps, and/or functions may also be added or not utilized without departing from the disclosure.

While features of the disclosure may have been discussed relative to certain implementations and figures, all implementations of the disclosure can include one or more of the advantageous features discussed herein. In other words, while one or more implementations may have been discussed as having certain advantageous features, one or more of such features may also be used in accordance with any of the various implementations discussed herein. In similar fashion, while exemplary implementations may have been discussed herein as device, system, or method implementations, it should be understood that such exemplary implementations can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. In some aspects, a process may correspond to a method, a function, a procedure, a subroutine, a subprogram, etc. When a process corresponds to a function, its termination corresponds to a return of the function to the calling function or the main function. One or more of the various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the implementations disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

Within the disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the disclosure, without limitation as to the type of electronic circuits, as well as software implementations of information and instructions that, when executed by a processor, enable the performance of the functions described in the disclosure.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

Accordingly, the various features associate with the examples described herein and shown in the accompanying drawings can be implemented in different examples and implementations without departing from the scope of the disclosure. Therefore, although certain specific constructions and arrangements have been described and shown in the accompanying drawings, such implementations are merely illustrative and not restrictive of the scope of the disclosure, since various other additions and modifications to, and deletions from, the described implementations will be apparent to one of ordinary skill in the art. Thus, the scope of the disclosure is only determined by the literal language, and legal equivalents, of the claims which follow.

What is claimed is:

1. A method of wireless communication, comprising:
allocating air interface resources of a base station between mobile access links and backhaul links;
receiving data packets at the base station;
routing, when the data packets were received on a first backhaul link, the data packets to a queue of a second backhaul link for transmission on select air interface resources of the air interface resources allocated for the second backhaul link;
routing, when the data packets were received on a third backhaul link, the data packets using a routing layer function to a higher layer function for local processing;
routing, when the data packets were received from a first mobile access link, the data packets to a queue of a fourth backhaul link for transmission on select air interface resources of the air interface resources allocated for the fourth backhaul link; and
routing, when the data packets were received from a fifth backhaul link, the data packets to a queue of a second mobile link for transmission on select air interface resources of the air interface resources allocated for the second mobile link.

2. The method of claim 1, further comprising:
routing, when the data packets were received from a sixth backhaul link, the data packets to a physical interface of a managed backhaul link.

3. The method of claim 1, further comprising:
routing, when the data packets were received from a port of a physical interface of a managed backhaul link, the data packets to a queue of a seventh backhaul link for transmission on select air interface resources of the air interface resources allocated for the seventh backhaul link.

4. The method of claim 1:
wherein the routing, when the data packets were received from the first mobile access link, the data packets to the queue of the fourth backhaul link for transmission on select air interface resources of the air interface resources allocated for the fourth backhaul link comprises:
encapsulating and routing the data packets to the queue of the fourth backhaul link for transmission on select air interface resources of the air interface resources allocated for the fourth backhaul link.

5. The method of claim 4:
wherein the routing the data packets is performed using Internet Protocol (IP); and
wherein the encapsulating the data packets comprises adding an IP header to each of the data packets.

6. The method of claim 1:
wherein the routing, when the data packets were received from the fifth backhaul link, the data packets to the queue of the second mobile link for transmission on select air interface resources of the air interface resources allocated for the second mobile link comprises:
routing, decapsulating, and forwarding the data packets to the queue of the second mobile link for transmission on select air interface resources of the air interface resources allocated for the second mobile link.

7. The method of claim 6:
wherein the routing of the data packets is performed using Internet Protocol (IP); and
wherein the decapsulating the data packets comprises removing an IP header from each of the data packets.

8. The method of claim 1:
wherein the routing of the data packets is performed using an L2 forwarding plane as defined by the IEEE 802.1 protocol; and
wherein the L2 forwarding plane is implemented using Ethernet.

9. The method of claim 1, further comprising:
autonomously integrating the base station into a routing plane and a core network.

10. The method of claim 1, further comprising:
transmitting, when the data packets were received on the first backhaul link, second data packets derived from the data packets of the queue of the second backhaul link on the select air interface resources of the air interface resources allocated for the second backhaul link;
transmitting, when the data packets were received from the first mobile access link, third data packets derived from the data packets of the queue of the fourth backhaul link on select air interface resources of the air interface resources allocated for the fourth backhaul link; and
transmitting, when the data packets were received from the fifth backhaul link, fourth data packets derived from the data packets of the queue of the second mobile link on select air interface resources of the air interface resources allocated for the second mobile link.

11. An apparatus for wireless communication, comprising:
a memory device;
a processing circuit coupled to the memory device and configured to:
allocate air interface resources of a base station between mobile access links and backhaul links;
receive data packets at the base station;
route, when the data packets were received on a first backhaul link, the data packets to a queue of a second backhaul link for transmission on select air interface resources of the air interface resources allocated for the second backhaul link;
route, when the data packets were received on a third backhaul link, the data packets using a routing layer function to a higher layer function for local processing;
route, when the data packets were received from a first mobile access link, the data packets to a queue of a fourth backhaul link for transmission on select air interface resources of the air interface resources allocated for the fourth backhaul link; and
route, when the data packets were received from a fifth backhaul link, the data packets to a queue of a second mobile link for transmission on select air interface resources of the air interface resources allocated for the second mobile link.

12. The apparatus of claim 11, wherein the processing circuit is further configured to route, when the data packets were received from a sixth backhaul link, the data packets to a physical interface of a managed backhaul link.

13. The apparatus of claim 11, wherein the processing circuit is further configured to route, when the data packets were received from a port of a physical interface of a managed backhaul link, the data packets to a queue of a seventh backhaul link for transmission on select air interface resources of the air interface resources allocated for the seventh backhaul link.

14. The apparatus of claim 11, wherein the processing circuit is further configured to:
encapsulate and route the data packets, when the data packets were received from the first mobile access link, to the queue of the fourth backhaul link for transmission on select air interface resources of the air interface resources allocated for the fourth backhaul link.

15. The apparatus of claim 14, wherein the processing circuit is further configured to:
route the data packets using Internet Protocol (IP); and
encapsulate the data packets by adding an IP header to each of the data packets.

16. The apparatus of claim 11, wherein the processing circuit is further configured to:
route, decapsulate, and forward, when the data packets were received from the fifth backhaul link, the data packets to the queue of the second mobile link for transmission on select air interface resources of the air interface resources allocated for the second mobile link.

17. The apparatus of claim 16, wherein the processing circuit is further configured to:
route the data packets using Internet Protocol (IP); and
decapsulate the data packets by removing an IP header from each of the data packets.

18. The apparatus of claim 11:
wherein the processing circuit is further configured to route the data packets using an L2 forwarding plane as defined by the IEEE 802.1 protocol; and
wherein the L2 forwarding plane is implemented using Ethernet.

19. The apparatus of claim 11:
wherein a system comprising:
the apparatus;
a routing plane; and
a core network,
is configured to autonomously integrate the base station into the routing plane and into the core network.

20. The apparatus of claim 11, wherein the processing circuit is further configured to:
transmit, when the data packets were received on the first backhaul link, second data packets derived from the data packets of the queue of the second backhaul link on the select air interface resources of the air interface resources allocated for the second backhaul link;
transmit, when the data packets were received from the first mobile access link, third data packets derived from the data packets of the queue of the fourth backhaul link on select air interface resources of the air interface resources allocated for the fourth backhaul link; and
transmit, when the data packets were received from the fifth backhaul link, fourth data packets derived from the data packets of the queue of the second mobile link on select air interface resources of the air interface resources allocated for the second mobile link.

21. An apparatus for wireless communication, comprising:
means for allocating air interface resources of a base station between mobile access links and backhaul links;
means for receiving data packets at the base station;
means for routing, when the data packets were received on a first backhaul link, the data packets to a queue of a second backhaul link for transmission on select air interface resources of the air interface resources allocated for the second backhaul link;
means for routing, when the data packets were received on a third backhaul link, the data packets using a routing layer function to a higher layer function for local processing;
means for routing, when the data packets were received from a first mobile access link, the data packets to a queue of a fourth backhaul link for transmission on select air interface resources of the air interface resources allocated for the fourth backhaul link; and
means for routing, when the data packets were received from a fifth backhaul link, the data packets to a queue of a second mobile link for transmission on select air interface resources of the air interface resources allocated for the second mobile link.

22. The apparatus of claim 21:
wherein the means for routing, when the data packets were received from the first mobile access link, the data packets to the queue of the fourth backhaul link for transmission on select air interface resources of the air interface resources allocated for the fourth backhaul link comprises:
means for encapsulating and routing the data packets to the queue of the fourth backhaul link for transmission on select air interface resources of the air interface resources allocated for the fourth backhaul link.

23. The apparatus of claim 22:
wherein a routing of the data packets is performed using Internet Protocol (IP); and
wherein the means for encapsulating the data packets comprises means for adding an IP header to each of the data packets.

24. The apparatus of claim 21:
wherein the means for routing, when the data packets were received from the fifth backhaul link, the data packets to the queue of the second mobile link for transmission on select air interface resources of the air interface resources allocated for the second mobile link comprises:
means for routing, decapsulating, and forwarding the data packets to the queue of the second mobile link for transmission on select air interface resources of the air interface resources allocated for the second mobile link.

25. The apparatus of claim 24:
wherein a routing of the data packets is performed using Internet Protocol (IP); and
wherein the means for decapsulating the data packets comprises means for removing an IP header from each of the data packets.

26. The apparatus of claim 25, further comprising:
means for transmitting, when the data packets were received on the first backhaul link, second data packets derived from the data packets of the queue of the second backhaul link on the select air interface resources of the air interface resources allocated for the second backhaul link;
means for transmitting, when the data packets were received from the first mobile access link, third data packets derived from the data packets of the queue of the fourth backhaul link on select air interface resources of the air interface resources allocated for the fourth backhaul link; and
means for transmitting, when the data packets were received from the fifth backhaul link, fourth data packets derived from the data packets of the queue of the second mobile link on select air interface resources of the air interface resources allocated for the second mobile link.

27. A non-transitory computer-readable medium storing computer-executable code, including code to:
allocate air interface resources of a base station between mobile access links and backhaul links;
receive data packets at the base station;
route, when the data packets were received on a first backhaul link, the data packets to a queue of a second backhaul link for transmission on select air interface resources of the air interface resources allocated for the second backhaul link;
route, when the data packets were received on a third backhaul link, the data packets using a routing layer function to a higher layer function for local processing;
route, when the data packets were received from a first mobile access link, the data packets to a queue of a fourth backhaul link for transmission on select air interface resources of the air interface resources allocated for the fourth backhaul link; and
route, when the data packets were received from a fifth backhaul link, the data packets to a queue of a second mobile link for transmission on select air interface resources of the air interface resources allocated for the second mobile link.

28. The computer-readable medium of claim 27, further including code to:
encapsulate and route the data packets, when the data packets were received from the first mobile access link, to the queue of the fourth backhaul link for transmission on select air interface resources of the air interface resources allocated for the fourth backhaul link.

29. The computer-readable medium of claim 28, further including code to:
route the data packets using Internet Protocol (IP); and
encapsulate the data packets by adding an IP header to each of the data packets.

30. The computer-readable medium of claim 27, further including code to:
route, decapsulate, and forward, when the data packets were received from the fifth backhaul link, the data packets to the queue of the second mobile link for transmission on select air interface resources of the air interface resources allocated for the second mobile link.

31. The computer-readable medium of claim 30, further including code to:
route the data packets using Internet Protocol (IP); and
decapsulate the data packets by removing an IP header from each of the data packets.

32. The computer-readable medium of claim 27, further including code to:
transmit, when the data packets were received on the first backhaul link, second data packets derived from the data packets of the queue of the second backhaul link on the select air interface resources of the air interface resources allocated for the second backhaul link;
transmit, when the data packets were received from the first mobile access link, third data packets derived from the data packets of the queue of the fourth backhaul link on select air interface resources of the air interface resources allocated for the fourth backhaul link; and
transmit, when the data packets were received from the fifth backhaul link, fourth data packets derived from the data packets of the queue of the second mobile link on select air interface resources of the air interface resources allocated for the second mobile link.
